(19) United States
(12) Patent Application Publication
(10) Pub. No.: US 2006/0219793 A1
(43) Pub. Date: Oct. 5, 2006

(54) Concealable device for discreetly providing confidential combination lock information to screening authorities at airports and the like

(76) Inventor: Richard J. Krulik, Dix Hills, NY (US)

Correspondence Address: ABELMAN, FRAYNE & SCHWAB, 666 THIRD AVENUE, 10TH FLOOR, NEW YORK, NY, 10017, US

(21) Appl. No.: 11/099,933

(22) Filed: Apr. 5, 2005

(51) Int. Cl. G06K 19/00; G07B 15/02; G06K 7/10

(52) U.S. Cl. 235/487; 235/384; 235/470

(57) ABSTRACT

A security device for use with luggage or other closable apparatus includes a card-shaped member composed of at least one layer of scanning-radiation-blocking material having a plurality of score-lines defining a section of the scanning-radiation-blocking material with at least one portion of the section capable of being readily and selectively removed by a user to form a user-customized aperture extending through the at least one layer of scanning-radiation-blocking material, with the user-customized aperture defining a user-selected numeral-shape, such that the card-shaped member, having the user-customized aperture therein, selectively blocks scanning radiation from a screening device to display the user-selected numeral-shape on a display of the screening device corresponding to a hidden combination code associated with the closable apparatus.

### BACKGROUND OF THE INVENTION

1. Field of the Invention

The present invention relates to devices for discreetly providing confidential combination lock information to screening authorities at airports and the like to provide the screening authorities with means for opening the luggage of a traveler without disclosing the information to other parties.

2. Description of the Related Art

With heightened security measures presently taking place at airports and other travel terminals it has been necessary to subject travelers and their luggage to intense scrutiny and screening procedures. For example, air travelers departing from major airports often are subjected to screening and examination prior to being permitted to board on commercial aircraft, while their luggage is often subjected to internal examination either by X-ray scanners, computed tomography (CT) scanners, and/or computerized axial tomography (CAT) scanners by such authorities as the Travel Security Administration (TSA).

Several efforts have been made to date to equip luggage with combination locks having a key override whereby the lock may be opened by the TSA screening authority utilizing one of a limited number of keys which they are provided with to override the combination lock and provide access to the contents of the luggage for screening purposes.

Efforts have also been made to avoid the need to require travelers to purchase combination locks having dual key override for various reasons. For example, often combination locks having a key override are more bulky than ordinary combination locks. Secondly, such locks are more expensive. Finally, their use is limited in that the official screening authorities must be provided with a limited number of such keys and each lock must bear a number which corresponds to the key which overrides the combination such that the screening authorities must first initially make note of the number of the lock and thereafter locate the appropriate key to override the combination.

One suggested proposal to simplify the manner of screening luggage by the TSA has been made whereby an identification tag will be provided with the luggage and which will include a tray which includes a plurality of upstanding guides arranged to form three arrays of the well-known digital figure-eight symbol. The purchaser will be supplied with this device when purchasing the luggage, or it may be purchased separately. After purchase, the user inserts an appropriate number of metal pieces which depict three numbers which correspond to the combination of the lock associated with the luggage. Thereafter, the tray is placed inside the identification tag which is snapped shut and hung on the outside of the bag. The TSA screeners will then subject the tag to an X-ray or CT scan machine and the metal numbers will be revealed by blocking the rays, allowing the screener to enter the luggage to examine the contents.

The tag is relatively bulky and must be hung outside the luggage. If it were placed inside the luggage, the metal numbers, which appear black on the X-ray machine, will tend to be confused with other articles (i.e. metal objects) in the luggage and may not be read correctly.

While this device is somewhat effective in providing screeners with access to the inside contents of the luggage without having to utilize extra devices such as keys or the like, the technique and the procedure can be simplified further by the present invention.

I have invented a relatively lightweight and simple card-type device which can be placed inside an article of luggage and can relatively easily and simply provide access to the lock combination to a TSA screener utilizing X-ray or CT scanner techniques without confusion with other articles in the luggage.

### BRIEF SUMMARY OF THE INVENTION

The present invention includes a security device having a card-shaped member composed of at least one layer of scanning-radiation-blocking material having a plurality of score-lines defining a section of the scanning-radiation-blocking material with at least one portion of the section capable of being readily and selectively removed by a user to form a user-customized aperture extending through the at least one layer of scanning-radiation-blocking material, with the user-customized aperture defining a user-selected numeral-shape, such that the card-shaped member, having the user-customized aperture therein, selectively blocks scanning radiation from a screening device to display the user-selected numeral-shape on a display of the screening device corresponding to a hidden combination code associated with a closable apparatus.

In one example embodiment, the closable apparatus is an article of luggage. The card-shaped member may be configured and dimensioned to be disposed within a pocket of the apparatus associated with the user. The pocket may be disposed within the interior of the closable apparatus. In another example embodiment, the at least one layer of scanning-radiation-blocking material includes zinc. Alternatively or in addition, the at least one layer of scanning-radiation-blocking material is capable of blocking X-rays and/or computed tomography (CT) radiation.

The plurality of score-lines may provide a plurality of removable sections arranged in at least one digital figure-eight pattern capable of forming any selected numerical digit after selective removal of at least one of the plurality of removable sections by the user. The card-shaped member may be associated with distinctive indicia viewable on an exterior surface of the closable apparatus, and such distinctive indicia may be a logo.

The present invention also includes an article of luggage, having an exterior surface; locking means for opening upon entry of a predetermined combination code; and a closable interior space accessible by the opening of the locking means, the interior space for receiving scanning radiation from a screening device, and the interior space including a pocket for receiving a card-shaped member, such that the card-shaped member is composed of at least one layer of scanning-radiation-blocking material having a plurality of score-lines defining a section of the scanning-radiation-blocking material with at least a portion of the section capable of being readily and selectively removed by a user to form a user-customized aperture extending through the at least one layer of scanning-radiation-blocking material, wherein the user-customized aperture defines a user-selected numeral-shape; and the card-shaped member, having the user-customized aperture therein, selectively blocks the scanning radiation from the screening device to display the user-selected numeral-shape on a display of the screening device corresponding to the predetermined combination code associated with the locking means.

The card-shaped member may be configured and dimensioned to be disposed within the pocket. The at least one layer of scanning-radiation-blocking material may include zinc. Alternatively or in addition, the at least one layer of scanning-radiation-blocking material is capable of blocking X-rays and/or computed tomography (CT) radiation. The plurality of score-lines may provide a plurality of removable sections arranged in at least one digital figure-eight pattern capable of forming any selected numerical digit after selective removal of at least one of the plurality of removable sections by the user. The card-shaped member may be associated with distinctive indicia viewable on an exterior surface of the apparatus, and such distinctive indicia may be a logo.

The present invention also includes a method of encoding a lock combination of a lock of a closable apparatus, with the method having the steps of: providing a card-shaped member associated with a closable apparatus and composed of at least one layer of scanning-radiation-blocking material; providing a plurality of score-lines in the at least one layer and defining a section of the scanning-radiation-blocking material; removing a selected portion of the section to form a user-customized aperture extending through the at least one layer of scanning-radiation-blocking material and defining a user-selected numeral-shape; directing scanning radiation from a screening device at the card-shaped member having the user-customized aperture; and selectively blocking the scanning radiation using the card-shaped member having the user-customized aperture, thereby causing the display of the user-selected numeral-shape on a display of the screening device corresponding to a hidden combination code associated with the closable apparatus. The at least one layer of scanning-radiation-blocking material may include zinc.

### BRIEF DESCRIPTION OF THE SEVERAL VIEWS OF THE DRAWINGS

Preferred embodiments of the invention are disclosed hereinbelow with reference to the drawings, wherein:

FIG. 1 is a front view of a card-type device according to the invention, incorporating three representations of digital “figure-eight” formed by score lines or otherwise weakening lines in an X-ray blocking material which score lines facilitate simply punching out the appropriate portions or sections to form the desired numeral in each of the three locations, the numerals representing a lock combination;

FIG. 2 is a perspective view of an article of luggage on a conveyor belt, having a built-in combination lock and an internal pocket which carries the card of FIG. 1 after the appropriate sections have been punched out to form an exemplary combination, “711”;

FIG. 3 is a cross-sectional view taken along lines 3-3 of FIG. 2 showing a pocket having an open top in which the card is slipped for containment;

FIG. 4 is a cross-sectional view taken along lines 4-4 of FIG. 2 wherein the pocket is provided with an open top to the customer, with additional means for sealing the open top after insertion of the combination card, as by adhesive cement, double sided tape, or the like; and

FIG. 5 is a perspective view of a piece of luggage on a conveyor belt, having a hang-type combination lock and an internal pocket which carries a card according to the invention.

### DETAILED DESCRIPTION OF THE INVENTION

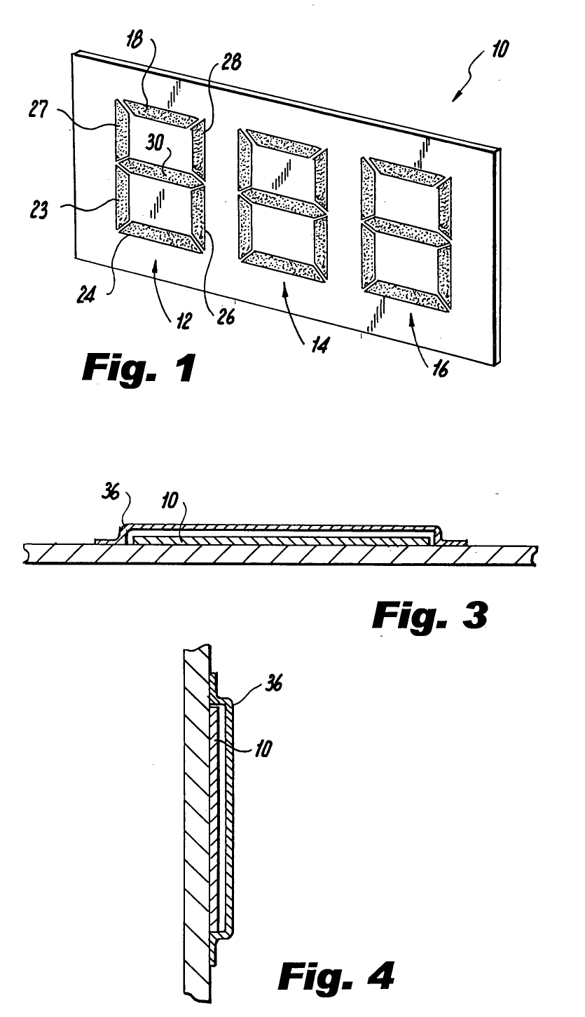

Referring initially to FIG. 1 there is disclosed a card-type device 10 which may be made of any X-ray or CT scan blocking material (i.e., cast zinc), or it may be layered and having at least one layer with such scanning-radiation blocking material. The scanning-radiation blocking material may be formed to have three spaced-apart sections or boxes 12, 14 and 16. The card-type device 10 may include any known chemical elements or compositions of scanning-radiation blocking material, such as cast zinc, lead amalgams, lead foil, and/or any combination thereof to form the sections 12, 14 and 16.

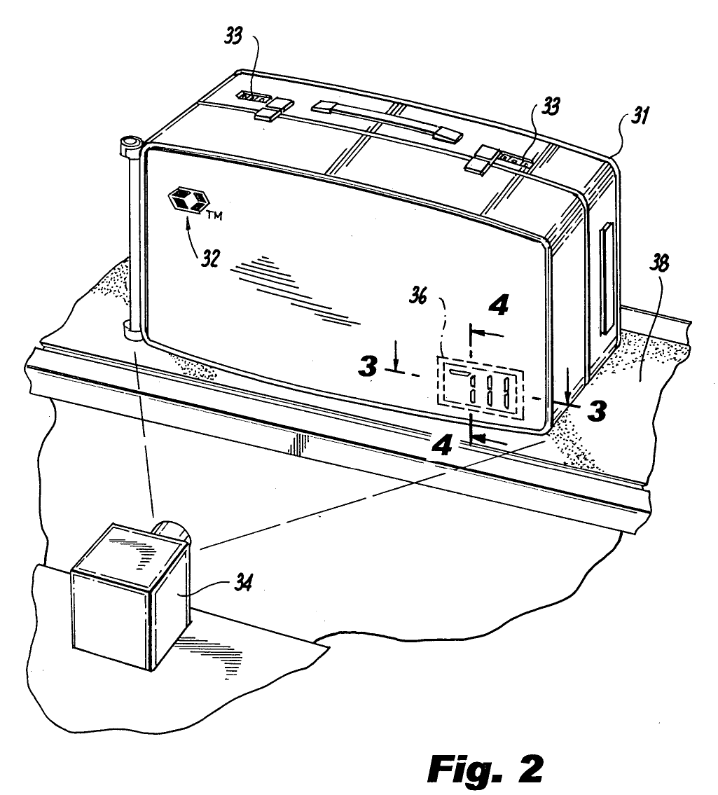

These sections 12, 14 and 16 each include a plurality of score lines, for example, score lines 23, 24, 26, 27, 28, and 30 for section 12, which essentially weaken the material to facilitate the easy punching out of user-selected portions of the appropriate sections by the user to form the desired numerals of a lock combination for opening a combination lock 33 as an example of locking means for accessing an interior space of an apparatus or article of the user. For example, as shown in the example embodiments in FIGS. 2-5, the apparatus may be an article of luggage 31 with which the user is traveling and which may be subject to screening by security personnel. Alternatively, the apparatus may be a knapsack, a duffel bag, a book bag, a briefcase, or other closable containers of the user traveling into a secured environment with screening equipment, such as an airport, a bus terminal, a courtroom or other government buildings, national monuments, a school or other educational buildings, large office buildings and skyscrapers, department stores and malls, etc. Accordingly, the apparatus having the combination lock 33 is not limited to an article of luggage for screening and examination.

The score lines 23, 24, 26, 27, 28 and 30 may be oriented in an array. The first array of score lines in box 12 will correspond to the first numeral of the combination of the lock 33, whereas the second array of score lines in box 14 will be utilized to form the second numeral of the combination of the lock 33, and the third array of score lines in box 16 will be utilized to form the third numeral of the combination of the lock 33. If the card is made entirely of an X-ray blocking material, each section will be punched out completely by the user. If the card is only layered with an X-ray blocking material in boxes 12, 14 and 16, only the layer of X-ray blocking material will be removed by the user.

It is well known by individuals familiar with computers and calculators that certain of the figure-eight array of lines shown in FIG. 1 can be selectively eliminated to form an appropriate numeral. For example, in the first array in box 12 of score lines, the digital figure-seven can be formed by eliminating the sections identified as 26, 28 and 18 thereby leaving spaces 23, 24, 27 and 30 to form the numeral “7”, as shown in FIG. 2. On the other hand, the numeral “1” can be formed by eliminating the sections identified as 26 and 28, thereby leaving spaces 18, 23, 24, 27 and 30, as shown in FIG. 2. As a third example the number “3” can be formed by eliminating the sections identified as 24, 26, 28, 18 and 30, thereby leaving spaces 23 and 27. It can be seen that by simply punching out the appropriate straight line sections defined by the appropriate score lines the card 10 will be left with spaces which actually form a number. The card can then be placed in a zippered pocket 36 inside the luggage and distinctive indicia, such as an appropriate label or logo, can be placed on the outside of the luggage to alert the screening authority, such as the TSA, that this luggage is equipped with such a card 10. Upon subjecting the article of luggage to an X-ray or CT scanner machine 34, the card 10 will either completely or partially block the rays (depending upon the material used), except where the spaces appear, so as to form the appropriate numerals visible on the display monitor of the screening terminal. By the presence of such spaces, the screener will be discreetly informed of the combination of the lock 33 attached to the outside of the luggage 31.

As noted, the scanning radiation, such as, for example, X-rays, will be completely or partially blocked in dependence upon the density of the scanning-radiation blocking material which is utilized to form the card 10. In other words the more dense the material is, the more blockage of X-rays which will occur. For example, one preferred embodiment will be in the form of a card 10 which can be made from an appropriate metal such as cast zinc with score lines being provided sufficient to enable the user to simply punch the appropriate sections out of the card 10 to form the correct number of the combination of the lock 33. Any material which will completely block or partially block X-rays is contemplated. In fact, if an alternative material can be made of sufficient density to block or to partially block X-rays sufficient to provide a distinction between the blocked X-rays and the unblocked X-rays to identify it will be sufficient. It is only necessary that a sufficient contrast of shading shows up on the display of the screener's machine.

In use, the card 10 is enclosed in an internal pocket 36 of an article of luggage 31, as shown in an example embodiment in FIGS. 2-3, with the article of luggage 31 placed upon a conveyor belt 38 to be screened. In the example embodiment, the article of luggage 31 has a built-in combination lock 33 and the internal pocket 36 which carries the card 10 of FIG. 1 after the appropriate sections have been punched out to form an exemplary combination “711”. Although the card 10 is internally disposed in the article of luggage 31, in response to scanning radiation from an X-ray or CT scanner machine 34, the combination “711” encoded on the card 10 will be displayed on a display of the scanner machine 34 for viewing by the screener to discreetly reveal the combination only to the screener and so to allow the article of luggage 31 to be opened and examined by the screener. However, other parties such as passengers and fellow travelers will not be able to determine the hidden combination since the card 10 is internally disposed.

In one example embodiment, the pocket 36 may have an open top in which the card 10 is slipped for containment, and which open top may then be closed and optionally secured, for example, by known fasteners.

FIG. 4 is a cross-sectional view taken along lines 4-4 of FIG. 2 wherein the pocket 36 is provided with an open top to the customer, with additional means such as fasteners for sealing the open top after insertion of the combination card, as by adhesive cement, double sided tape, or the like.

In an alternative embodiment, the card of FIG. 1 can simply be placed in a zippered pocket 36 thereby avoiding the need to attract attention to others that the combination of the lock 33 on the outside of the luggage 31 is actually contained inside the luggage. By placing the card 10 inside the bag or luggage 31, and by disclosing the numerals by the absence of X-ray blocking material, there will be no confusion between the numerals and items stored in the remaining contents of the luggage, as there may be in prior art devices.

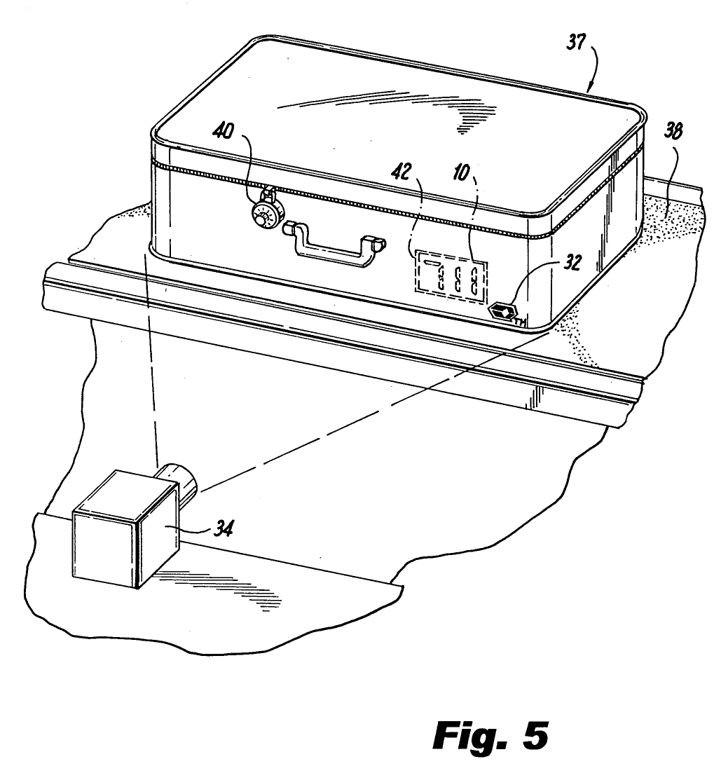

As noted, the distinctive indicia 32 such as an identifying logo can be placed on an exterior surface, such as the outside of the bag 31, to be viewable to screeners, with such distinctive indicia 32 being associated with the use of the card 10 to alert the TSA that the bag 31 is equipped with a means for disclosing the combination by X-rays or other known scanning techniques. For example, the well known logo promoted as a trademark by Travel Sentry, Inc., as shown as an example of the indicia 32 on the bag 31 in FIGS. 2 and 5, can be placed on the bag 31 to identify the bag 31 as one having an internally placed combination source. Other suitable logos or indicia may be provided.

As an alternative embodiment, the card 10 of FIG. 1 can also be placed in an internal pocket of a piece of luggage which can be provided with the luggage as a pocket which is sealable by a zipper or permanently sealable, once the card is removed, altered to display the combination, and replaced into the pocket. The pocket can be provided with a super strength adhesive and release paper on each surface to permit permanently sealing the pocket, such that once the card is sealed into the pocket physical access to the card is not available without destruction of the bag. An appropriate adhesive might be contact cement, or double sided tape.

As noted, it is only necessary to provide a card of material having sufficient density to fully or partially block the X-rays or other scanning radiation of the TSA screening machines to permit passage therethrough to provide the screeners with the appropriate combination number or code of the combination lock 33.

Referring to FIG. 5 there is shown an article of luggage 37 on a conveyor belt 38 having a padlock-type combination lock 40 as another embodiment of locking means of a closable portion of the luggage 37, with an internal pocket 42 containing a card 10 according to the present invention, with the card 10 encoding the combination of the combination lock 40. An X-ray or CT scanner machine 34 is also shown in FIG. 5, such that the scanning radiation therefrom reveals the combination of “711” to the screener on the display of the scanner machine 34 for opening the lock 40 and examining the contents of the article of luggage 37.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

1. A security device comprising:
a card-shaped member composed of at least one layer of scanning-radiation-blocking material having:
a plurality of score-lines defining a section of the scanning-radiation-blocking material with at least one portion of the section capable of being readily and selectively removed by a user to form a user-customized aperture extending through the at least one layer of scanning-radiation-blocking material, wherein the user-customized aperture defines a user-selected numeral-shape;
wherein the card-shaped member, having the user-customized aperture therein, selectively blocks scanning radiation from a screening device to display the user-selected numeral-shape on a display of the screening device corresponding to a hidden combination code associated with a closable apparatus.

2. The security device of claim 1, wherein the closable apparatus is an article of luggage.

3. The security device of claim 1, wherein the card-shaped member is configured and dimensioned to be disposed within a pocket of the apparatus associated with the user.

4. The security device of claim 3, wherein the pocket is disposed within the interior of the closable apparatus.

5. The security device of claim 1, wherein the at least one layer of scanning-radiation-blocking material includes zinc.

6. The security device of claim 1, wherein the at least one layer of scanning-radiation-blocking material is capable of blocking X-rays.

7. The security device of claim 1, wherein the at least one layer of scanning-radiation-blocking material is capable of blocking computed tomography (CT) radiation.

8. The security device of claim 1, wherein the plurality of score-lines provide a plurality of removable sections arranged in at least one digital figure-eight pattern capable of forming any selected numerical digit after selective removal of at least one of the plurality of removable sections by the user.

9. The security device of claim 1, wherein the card-shaped member is associated with distinctive indicia viewable on an exterior surface of the closable apparatus.

10. The security device of claim 9, wherein the distinctive indicia is a logo.

11. An article of luggage, comprising:
an exterior surface;
locking means for opening upon entry of a predetermined combination code; and
a closable interior space accessible by the opening of the locking means, the interior space for receiving scanning radiation from a screening device, the interior space including:
a pocket for receiving a card-shaped member;
wherein the card-shaped member is composed of at least one layer of scanning-radiation-blocking material having a plurality of score-lines defining a section of the scanning-radiation-blocking material with at least a portion of the section capable of being readily and selectively removed by a user to form a user-customized aperture extending through the at least one layer of scanning-radiation-blocking material, wherein the user-customized aperture defines a user-selected numeral-shape; and
wherein the card-shaped member, having the user-customized aperture therein, selectively blocks the scanning radiation from the screening device to display the user-selected numeral-shape on a display of the screening device corresponding to the predetermined combination code associated with the locking means.

12. The article of luggage of claim 11, wherein the card-shaped member is configured and dimensioned to be disposed within the pocket.

13. The article of luggage of claim 11, wherein the at least one layer of scanning-radiation-blocking material includes zinc.

14. The article of luggage of claim 11, wherein the at least one layer of scanning-radiation-blocking material is capable of blocking X-rays.

15. The article of luggage of claim 11, wherein the at least one layer of scanning-radiation-blocking material is capable of blocking computed tomography (CT) radiation.

16. The article of luggage of claim 11, wherein the plurality of score-lines provide a plurality of removable sections arranged in at least one digital figure-eight pattern capable of forming any selected numerical digit after selective removal of at least one of the plurality of removable sections by the user.

17. The article of luggage of claim 11, wherein the card-shaped member is associated with distinctive indicia viewable on an exterior surface of the apparatus.

18. The article of luggage of claim 17, wherein the distinctive indicia is a logo.

19. A method of encoding a lock combination of a lock of a closable apparatus, the method comprising the steps of:
providing a card-shaped member associated with a closable apparatus and composed of at least one layer of scanning-radiation-blocking material;
providing a plurality of score-lines in the at least one layer and defining a section of the scanning-radiation-blocking material;
removing a selected portion of the section to form a user-customized aperture extending through the at least one layer of scanning-radiation-blocking material and defining a user-selected numeral-shape;
directing scanning radiation from a screening device at the card-shaped member having the user-customized aperture; and
selectively blocking the scanning radiation using the card-shaped member having the user-customized aperture, thereby causing the display of the user-selected numeral-shape on a display of the screening device corresponding to a hidden combination code associated with the closable apparatus.

20. The method of claim 19, wherein the at least one layer of scanning-radiation-blocking material includes zinc.
